(19) United States
(12) Patent Application Publication
(10) Pub. No.: US 2018/0084029 A1
(43) Pub. Date: Mar. 22, 2018

(54) Telecom ciber-bypass system so computers which are not on the internet can receive files

(71) Applicant: Michael Lynn Froelich, Austin, TX (US)

(72) Inventor: Michael Lynn Froelich, Austin, TX (US)

(21) Appl. No.: 15/330,437

(22) Filed: Sep. 21, 2016

(51) Int. Cl. H04L 29/08

(52) U.S. Cl. CPC H04L 67/06

(57) ABSTRACT

The present invention relates to a system for sending dense data over telephone company lines as an alternative to the common usage of the Internet. The internet is vulnerable to penetration, making data and files sent over it insecure. Current users of the Internet sending or receiving files or data can use my system, which sends content from computer to computer using telephone lines.

### FIELD OF THE INVENTION

The present invention relates to computers and other digital devices which ordinarily would use the internet to exchange or transfer dense data such as large files or interactive files for which the owner seeks to perform these exchanges without connecting their device to the internet and incur the security risks involved thereby.

### BACKGROUND

Connecting computers and other digital devices with important files and programs to the internet is dangerous. Security methods for protecting computers and other devices from malicious penetration via the internet are ineffective and expensive. All threats from being connected to the internet can be solved by disconnecting computers with important programs and files from the internet. Computers can be disconnected from the internet and still send files on the Internet using other computers which are connected to the internet and transfer files to the internet-connected computer using various external devices for data storage and transfer such as flashdrives, disks, or internal transfer devices such as Data Ferry (™). As yet though there is no system for computers or other devices disconnected from the internet to exchange, or receive dense data files or send interactive files from and to other remote computers.

Although presently telephone or telecommunications modems exist they are cumbersome exterior devices which are limited in their ability to send or receive dense data or complex digital files such as computers and other devices commonly do over the internet. Unfortunately parties promoting the internet for transferal of data have largely failed to disclose the risks to users of employing the internet for transferal of confidential, sensitive or private data. Therefore it has become common for users of the internet to use the internet to transfer dense and other data and to have such data intercepted or damaged.

My invention permits computer and other device users to send and receive complex files, dense data and interactive files over telecommunications lines and pathways operated by telecommunications companies and agencies and thereby by-pass the internet and avoid the dangers of connection to it.

### SUMMARY OF THE INVENTION

As stated above, connecting computers and other digital devices to the internet is dangerous. Security methods for seeking to protect devices and computers from malicious penetration via the internet are ineffective and expensive. All threats from being connected to the internet can be eliminated by disconnecting computers with important or sensitive programs and files from the internet. Computers can be disconnected from the internet and still send files on the internet using a second computer or device which is connected to the internet to send the desired file and move the file from the computer not connected to the internet to the one which is using a variety of data storage devices. As yet though there is no efficient system for computers disconnected from the internet to receive dense or other files or send interactive files without being connected to the internet. Using a second computer and moving a desired file to it can be used to send files to other computers via the internet. But to do so by-passing the internet, and to use telecommunications lines or other means to send and receive, to exchange, interactive files is not yet available until my invention. Therefore the invention claimed solves these problems.

My invention makes it possible for computers and other devices which are not connected to the Internet to exchange, send and receive data files from and to other computers by having a built-in device which receives dense data comprising files from and to other computers via telephone lines or cellular telephone transmissions thereby avoiding the internet.

The claimed invention differs from what currently exists. Unlike present telephone modems my system is built into the computer case, or device body, is integral to the device or computer, and can receive and send interactive and other dense data files conveniently.

Existing telephone modems have not been improved sufficiently since the advent of the internet, nor have they been improved sufficiently since the availability of larger data stream bandwidths presently available through fiber optic lines or 4G cellular transmissions or other high density pathways.

My invention permits computers to use telecommunications fiber optics and dense data cellular transmissions to send and receive complex files as computers routinely do over the internet presently, including interactive files.

Also, it can produce any digital device such as a tablet, smartphone, etc., which is intended to receive and/or send digital files comparable to those used by modern computers.

### BRIEF DESCRIPTION OF THE DRAWINGS

Having thus described the invention and it's components, reference will now be made to the accompanying drawing, which is not necessarily to scale, and wherein:

FIG. 1 is a schematic diagram of the invention, showing a a computer equipped with my invention. The schematic displays a computer case within which resides internal common computer components. The components of the computer are connected electronically and digitally to a new kind of high speed modem, a telecommunications processor, which allows digital data such as files and any other kind of data to be sent over a high density data transmission pathway operated by a telecommunications party, agency, or any other organization operating high density, high speed teleommunications equipment and services. The telecommunications processor is connected by transmission lines of a variety of types two either a cellular device operated by the computer user, or to the point of connection of the telecommunications provider.

### DETAILED DESCRIPTION OF THE INVENTION

The present invention now will be described more fully herein with reference to the accompanying drawing, in which some examples of the embodiments of the invention are shown. Indeed, these inventions may be embodied in many different forms and should not be construed as limited to the embodiment set forth herein; rather, these embodiments are provided by way of example so that this disclosure will satisfy applicable legal requirements.

Like numbers refer to like elements throughout.

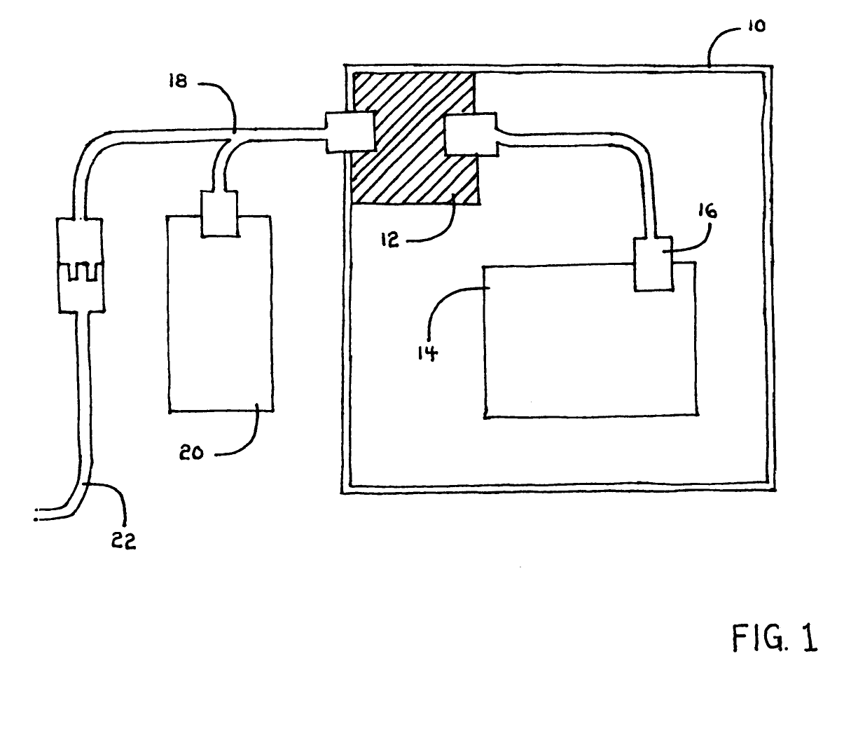

FIG. 1 Is a schematic illustration depicting the basic components of the invention in which 10 is the computer case. The components internal to the computer which are commonly found in all computers such as processors and storage devices within the computer case is represented by 14. From the internal components of the computer runs a data connector allowing data from the computer's components to flow to a new kind of powerful telephone modem, or telecommunications processor, represented by 12, which also resides within the computer case. The telecom processor is connected to exterior telecommunications devices by means of a connector, 18, which is displayed connected to two different telecommunications devices, a cellular device represented by 20, and a route for non-cellular telecommunication sourcing such as a fiber optic line 22.

### DRAWING DESCRIPTION

FIG. 1: is a schematic diagram of the invention

### DESCRIPTION LIST

10: is the computer case

12: is the telecommunications processor/new kind of modem

14: are the internal components of the computer

16: is the connection between the telecom processor and the internal components computer

18: is the connection between the telecom processor and exterior telecom devices

20: is a cellular telephone

22: is a route for a non-cellular telecom source such as fiber optic

1. The invention permits computers and other digital devices to send and receive dense data streams using telecommunications pathways such as fiber optic lines and 4G wireless transmission, commonly operated by telecommunications companies and agencies, thereby by-passing the internet for transferal of dense data content such as files.

2. The invention permits computers to by-pass the internet for exchange of dense data content and thereby avoid the risks of connection to the internet and subsequent and inherent risks of penetration from outside, undesired sources, and thereby retain the security of files and data stored in computers and other devices.

3. The invention permits the construction of computer networks which can exchange dense data while by-passing the internet, which is currently commonly used for these functions, and thereby permit the systems of such networks to maintain security from penetration because they can exchange data without ever being connected to the internet.

4. The invention permits the construction of computers which contain high speed and high density modems internally such that these digital devices can by-pass the internet and be used conveniently by computer and device operators.

5. The invention permits the construction of high speed modems which are of sufficient capacity and speed such that they can take advantage of the bandwidth and data transferal capacity of fiber optic lines, 4G wireless transmission, and other high density telecommunications devices heretofore unavailable.

6. This invention permits data devices other than computers to also exchange dense data securely by using telecommunications pathways and thereby by-pass the internet and allowing such functions without being connected to the internet.
